(19) United States
(12) Patent Application Publication
(10) Pub. No.: US 2026/0187469 A1
(43) Pub. Date: Jul. 2, 2026

(54) INFORMATION PROCESSING APPARATUS

(71) Applicants: NEC Corporation, Tokyo (JP); NEC Solution Innovators, Ltd., Tokyo (JP)

(72) Inventors: Fumiyo TAKANO, Tokyo (JP); Kazushi Marukawa, Tokyo (JP)

(73) Assignees: NEC Corporation, Tokyo (JP); NEC Solution Innovators, Ltd., Tokyo (JP)

(21) Appl. No.: 19/408,582

(22) Filed: Dec. 4, 2025

(30) Foreign Application Priority Data
Dec. 27, 2024 (JP) 2024-232734

(51) Int. Cl. G06N 3/091

(52) U.S. Cl. CPC G06N 3/091

(57) ABSTRACT

An information processing apparatus of the present disclosure includes a storing unit that stores corresponding data in which a problem expression and a conversion formula derived by converting the problem expression by expanding and organizing the problem expression are associated with each other, and a conversion unit that, on the basis of the corresponding data, converts an optimization problem including the problem expression into a predetermined form using the conversion formula. This architecture accelerates decision making in AI-based combinatorial optimization tasks.

### INCORPORATION BY REFERENCE

This application is based upon and claims the benefit of priority from Japanese patent application No. 2024-232734, filed on Dec. 27, 2024, the disclosure of which is incorporated herein in its entirety by reference.

### TECHNICAL FIELD

The present disclosure relates to an information processing apparatus.

### BACKGROUND ART

As a method for solving real-world problems, it has been practiced to formulate the energy in a combinatorial optimization problem into a form of an Ising model and solve it accordingly. For example, as described in Patent Literature 1, the energy of an optimization problem is formulated in a QUBO (Quadratic Unconstrained Binary Optimization) form and solved using simulated annealing.

Patent Literature 1: JP 2022-67101 A

### SUMMARY

However, when solving an optimization problem, it is necessary to convert it into a form such as QUBO, and when the problem scale is large, there is a problem that the conversion process takes time.

Therefore, an exemplary object of the present disclosure is to solve the aforementioned problem, that is, a problem that conversion of an optimization problem into a predetermined form takes time.

An information processing apparatus, according to one aspect of the present disclosure, is configured to include
a storing unit that stores therein corresponding data in which a problem expression and a conversion formula derived by converting the problem expression by expanding and organizing the problem expression are associated with each other, and
a conversion unit that, on the basis of the corresponding data, converts an optimization problem including the problem expression into a predetermined form using the conversion formula.

Further, an information processing method, according to one aspect of the present disclosure, is configured to include,
on the basis of corresponding data that is stored and in which a problem expression and a conversion formula derived by converting the problem expression by expanding and organizing the problem expression are associated with each other, converting an optimization problem including the problem expression into a predetermined form using the conversion formula.

Further, a program, according to one aspect of the present disclosure, is configured to cause an information processing apparatus to execute processing to,
on the basis of corresponding data that is stored and in which a problem expression and a conversion formula derived by converting the problem expression by expanding and organizing the problem expression are associated with each other, convert an optimization problem including the problem expression into a predetermined form using the conversion formula.

With the configuration as described above, the present disclosure is able to reduce the time required for converting an optimization problem into a predetermined form.

### BRIEF DESCRIPTION OF DRAWINGS

FIG. 1 is a block diagram illustrating an example configuration of an information processing apparatus according to the present disclosure;

FIG. 2 is a flowchart illustrating an example processing operation by the information processing apparatus according to the present disclosure;

FIG. 3 illustrate an example of data related to the present disclosure;

FIG. 4 illustrates an example of data related to the present disclosure;

FIG. 5 illustrates an example of data related to the present disclosure;

FIG. 6 is a block diagram illustrating an example of a hardware configuration of an information processing apparatus according to the present disclosure;

FIG. 7 is a block diagram illustrating an example of a configuration of an information processing apparatus according to the present disclosure; and

FIG. 8 is a flowchart illustrating an example processing operation by the information processing apparatus according to the present disclosure.

### EXAMPLE EMBODIMENTS

### First Example Embodiment

A first example embodiment of the present disclosure will be described with reference to the drawings. Note that the drawings may be associated with any example embodiments.

An information processing apparatus of the present disclosure is used to, for example, convert a preset constrained combinatorial optimization problem into a formulated model. In particular, in this example embodiment, converting a combinatorial optimization problem into a QUBO (Quadratic Unconstrained Binary Optimization) model will be described as an example.

A constrained combinatorial optimization problem is a problem in which an objective function and constraints are set and a solution that minimizes the objective function while satisfying the constraints is sought. Such a constrained combinatorial optimization problem can be converted into a QUBO model as shown in Expressions 1 and 2. At this time, the constrained combinatorial optimization problem can be expressed in such a manner that an energy value E of the optimization problem is expressed using objective function terms (the first and second terms) and constraint terms (the third and fourth terms) as shown in Expression 1, and they can be combined into a single model as shown in Expression 2.

$$E = {\sum }_{i} {\sum }_{j} {J}_{ij}^{′} {s}_{i} {s}_{j} + {\sum }_{i} {h}_{i}^{′} {s}_{i} + {\sum }_{i} {\sum }_{j} {\hat{J}}_{ij} {s}_{i} {s}_{j} + {\sum }_{i} {\hat{h}}_{i}^{′} {s}_{i} \qquad [ Expression 1 ]$$

$$E = {\sum }_{i} {\sum }_{j} {J}_{ij} {s}_{i} {s}_{j} + {\sum }_{i} {h}_{i} {s}_{i} = {\sum }_{i} {\sum }_{j} {Q}_{ij} {s}_{i} {s}_{j} \qquad [ Expression 2 ]$$

In the above expressions, sᵢ and sⱼ are variables representing the states of spins si and sj, and are expressed as “0” or “1”. Here, i and j are identification numbers of the spin s. Also, Qᵢⱼ in Expression (2) is a weight parameter set corresponding to each combination of the spins sᵢ and sⱼ, and is referred to as a QUBO matrix.

The constrained combinatorial optimization problem can be solved by finding a spin that minimizes the energy E using a method called simulated annealing (pseudo quantum annealing), thereby obtaining the optimal solution. At this time, the state of the spin s flips from 0 to 1 or from 1 to 0, causing the solution to transition and be explored accordingly. In the simulated annealing, when searching for a solution, a transition always occurs if the evaluation value of a neighboring solution is better (smaller), but even if the evaluation value of the neighboring solution is worse (larger), a transition can still occur probabilistically. The probability at this time is determined by the inverse temperature that is a reciprocal of the temperature parameter value, so that the search for solutions proceeds while increasing or decreasing the inverse temperature.

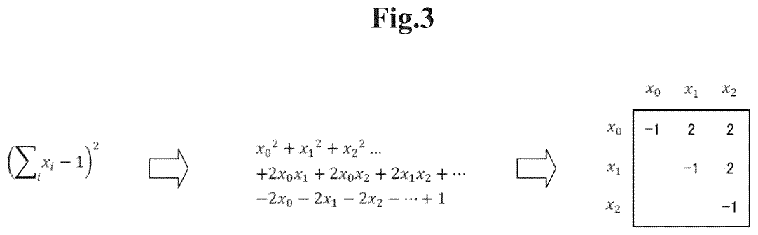

Here, the QUBO matrix represented by Qᵢⱼ in Expression 2 is obtained as a coefficient matrix of the respective variables in the expression converted into the QUBO form by expanding and organizing the expression of the optimization problem. For example, when the expression of the optimization problem before conversion is the problem expression shown in Expression 3 below, it can be expanded and reorganized as shown in Expression 4. Then, as illustrated in FIG. 3, a 3×3 QUBO matrix, which is a coefficient matrix of the respective variables in Expression 4, can be obtained. Since x represents a binary variable, x²=x, which results in a QUBO matrix as illustrated in FIG. 3.

$${( {\sum }_{i} {x}_{i} - 1 )}^{2} \qquad [ Expression 3 ]$$

$${x}_{0}^{2} + {x}_{1}^{2} + {x}_{2}^{2} … + 2 {x}_{0} {x}_{1} + 2 {x}_{0} {x}_{2} + 2 {x}_{1} {x}_{2} + ⋯ - 2 {x}_{0} - 2 {x}_{1} - 2 {x}_{2} - ⋯ + 1 \qquad [ Expression 4 ]$$

On the other hand, as described above, computational processing is required to expand and organize the optimization problem and convert it into a QUBO form, and as the problem size of the optimization problem increases, the computational complexity rises, resulting in longer processing times. Therefore, the information processing apparatus in this present disclosure is configured as follows to suppress the computational complexity and the processing time when converting the optimization problem into a QUBO-form model.

Hereinafter, the case where a constrained optimization problem, as described above, is formulated and handled as an unconstrained optimization problem will be mainly described as an example. However, this is also applicable to the cases where a constrained optimization problem is handled directly, as well as to other optimization problems such as constrained linear programming problems. Additionally, the case where an optimization problem is converted into a QUBO form will be mainly described below but this approach is also applicable when converting to an Ising model form where the spins sᵢ and sⱼ mentioned above are represented by “−1” or “1”.

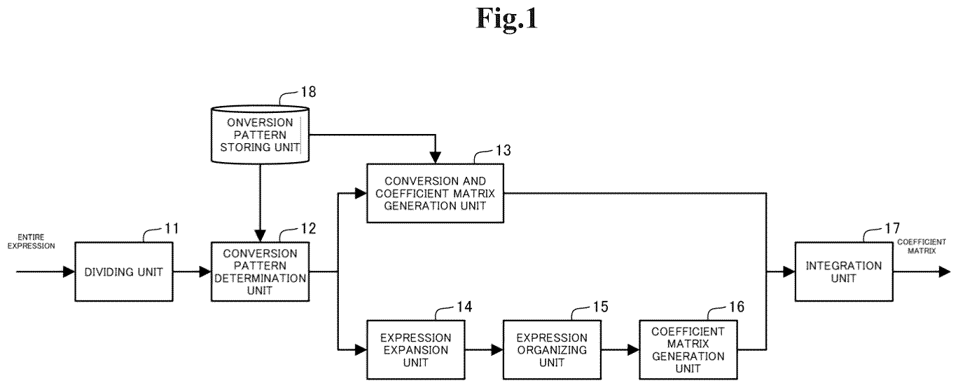

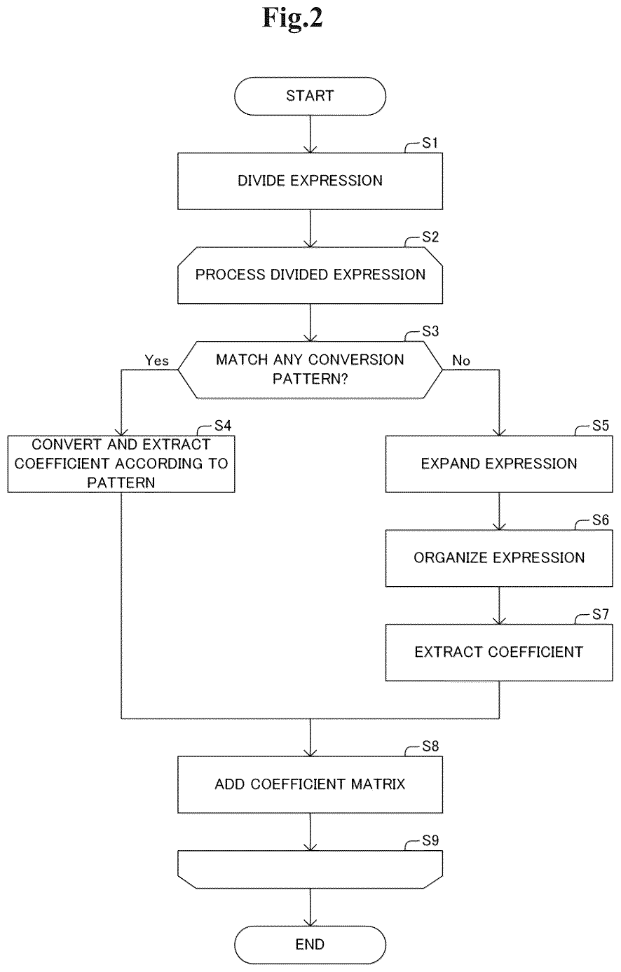

Examples of the configuration and operation of the information processing apparatus in this example embodiment will be described in detail. FIG. 1 illustrates an example configuration of the information processing apparatus, and FIG. 2 illustrates an example operation of the information processing apparatus. The information processing apparatus is configured of one or a plurality of information processing apparatuses each including an arithmetic logic unit and a memory unit. As illustrated in FIG. 1, the information processing apparatus includes a dividing unit 11, a conversion pattern determination unit 12, a conversion and coefficient matrix generation unit 13, an expression expansion unit 14, an expression organizing unit 15, a coefficient matrix generation unit 16, and an integration unit 17. The functions of the dividing unit 11, the conversion pattern determination unit 12, the conversion and coefficient matrix generation unit 13, the expression expansion unit 14, the expression organizing unit 15, the coefficient matrix generation unit 16, and the integration unit 17 can be realized by the arithmetic logic unit executing programs for realizing the respective functions stored in the storage device. In addition, the information processing apparatus 10 includes a conversion pattern storing unit 18 implemented in the storage device.

The conversion pattern storing unit 18 (storing unit) stores conversion patterns each consisting of corresponding data in which a problem expression and a conversion formular derived by converting the problem expression by expanding and organizing it are associated with each other. A problem expression is an expression included in an optimization problem and is patterned. For example, a problem expression is a patterned expression in which Expression 1 is pattered as “square of (addition of variables without coefficients-constant)” shown by the following Expression 5. By expanding and organizing the problem expression of Expression 5, it can be converted into a conversion formula as shown in Expression 6. As described above, the corresponding data designated as a conversion pattern is configured such that the problem expression and the conversion formula are associated with each other. Expressions 5 and 6 show the cases where the problem expression is represented as a mathematical formula and by a program, respectively.

$$Expression example : {( {\sum }_{i} {x}_{i} - C )}^{2} \qquad [ Expression 5 ]$$

$$Program example : {( sum ( x [ i ] for i in 0 … N ) - C )}^{⋀} 2$$

C represents an integer constant, and 0 . . . N represents a range from 0 to less than N.

$$Expression example : + 2 C {x}_{0} {x}_{1} + 2 C {x}_{0} {x}_{2} + 2 C {x}_{1} {x}_{2} + ⋯ + ( - 2 C + 1 ) {x}_{1} + ( - 2 C + 1 ) {x}_{2} + ⋯ + {C}^{2} \qquad [ Expression 6 ]$$

```
Program example: (sum(2*x[i]*x[j] for i, j in combination(0...N))
  +(sum((−2C+1)*x[i] for i in 0...N)
  +C*C
```

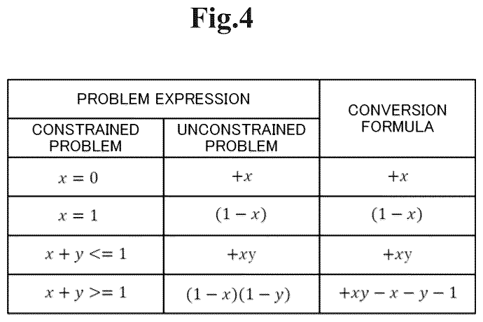

The above-described conversion pattern is merely an example, and a conversion pattern may be configured such that any problem expression and a conversion formula are associated with each other. Other examples of conversion patterns are illustrated in FIG. 4. FIG. 4 illustrates, in the respective rows, conversion patterns in which problem expressions in the case of a constrained optimization problem and the case of an unconstrained optimization problem and a conversion formula are associated with each other.

Moreover, the conversion pattern may be stored in advance in the conversion pattern storing unit 18, or may be added and stored in the conversion pattern storing unit 18 afterwards as described later. For example, as described later, corresponding data in which a problem expression included in the optimization problem input to the information processing apparatus and a conversion formula in which the problem expression is expanded and organized by the expression expansion unit 14 and the expression organizing unit 15 are associated with each other, may be stored as a conversion pattern in the conversion pattern storing unit 18.

Next, the processing functions of the information processing apparatus will be described. As an example, the entire expression of the optimization problem, such as the above-mentioned Expression (3) and Expression (7) below, is input to the information processing apparatus.

$$Expression example : {\sum }_{j} {( {\sum }_{i} {x}_{i , j} - 1 )}^{2} \qquad [ Expression 7 ]$$

$$Program example : forall ( j in 0 … M ) ( {( sum ( x [ i ] [ j ] for i in 0 … N ) - 1 )}^{⋀} 2 )$$

The dividing unit 11 accepts the input optimization problem and divides the optimization problem into problem expressions in predetermined units (step S1 in FIG. 2). At this time, the dividing unit 11 divides it into problem expressions in units represented by monomials or polynomials like those registered as a conversion pattern, for example. As an example, the optimization problem shown in Expression 3 cannot be further divided and is therefore handled as is it as a problem expression. As another example, the optimization problem shown in Expression 7 is divided into a problem expression representing the summation described in the former part and a problem expression of the squared term described in the latter part. Then, the dividing unit 11 inputs the optimization problem divided into the problem expressions to the conversion pattern determination unit 12. Note that the dividing unit 11 is not limited to dividing the optimization problem using a single division pattern, but may divide it using a plurality of division patterns, that is, a plurality of division patterns with different division points, and the optimization problem in a state of being divided into the problem expressions in the respective division patterns may be input to the conversion pattern determination unit 12. Then, processing will be performed on each of the divided problem expressions (step S2 in FIG. 2).

The conversion pattern determination unit 12 (determination unit) performs pattern determination to determine whether or not the problem expression included in the optimization problem, that is, the divided problem expression, is included in the conversion patterns stored in the conversion pattern storing unit 18 (step S3 in FIG. 2). For example, the squared problem expressions in Expression 3 and Expression 7 described above are registered as problem expressions of the conversion patterns, so that they are determined to be conversion patterns (Yes at step S3 in FIG. 2). Then, the conversion pattern determination unit 12 inputs the problem expression determined to be a conversion pattern to the conversion and coefficient matrix generation unit 13. On the other hand, when the problem expression is not registered as a problem expression of a conversion pattern, the conversion pattern determination unit 12 determines that it is not a conversion pattern (No at step S3 in FIG. 2) and inputs such a problem expression to the expression expansion unit 14. The conversion pattern determination unit 12 performs pattern determination collectively for all problem expressions included in the optimization problem.

The conversion and coefficient matrix generation unit 13 (conversion unit) converts the problem expression determined to be a conversion pattern into a conversion formula on the basis of the conversion pattern stored in the conversion pattern storing unit 18. For example, the squared problem expressions in Expressions 3 and 7 are converted into the conversion formula shown in Expression 6 according to the conversion pattern consisting of the corresponding data between the aforementioned Expressions 5 and 6. Then, the conversion and coefficient matrix generation unit 13 further generates a coefficient matrix of the respective variables in the conversion formula after the conversion (step S4 in FIG. 2). For example, the squared problem expressions in Expressions 3 and 7 are converted into a 3×3 coefficient matrix illustrated in FIG. 3 on the basis of the conversion formula in Expression 6. Note that the conversion and coefficient matrix generation unit 13 may simply perform conversion to the conversion formula. That is, the conversion and coefficient matrix generation unit 13 may convert the problem expression into the form of a conversion formula or into the form of a coefficient matrix.

On the other hand, the problem expression determined not to be a conversion pattern is processed by the expression expansion unit 14, the expression organizing unit 15, and the coefficient matrix generation unit 16 (conversion unit). The expression expansion unit 14 expands the problem expression determined not to be a conversion pattern (step S5 in FIG. 2), and the expression organizing unit 15 organizes the expanded problem expression and converts it into a conversion formula (step S6 in FIG. 2). Then, the coefficient matrix generation unit 16 generates a coefficient matrix of the respective variables in the conversion formula derived by expanding and organizing the problem expression (step S7 in FIG. 2). The expression expansion unit 14 and the expression organizing unit 15 may store the corresponding data between the problem expression before expansion and organization and the conversion formula after the expansion and organization in the conversion pattern storing unit 18 as a new conversion pattern.

The integration unit 17 (conversion unit) adds the coefficient matrix generated by the conversion and coefficient matrix generation unit 13 and the coefficient matrix generated through processing by the expression expansion unit 14, the expression organizing unit 15, and the coefficient matrix generation unit 16 (step S8 in FIG. 2). Then, by performing the aforementioned processing on each divided problem expression, all coefficient matrices are integrated to generate one coefficient matrix (steps S2 to S9 of FIG. 2 are repeated). For example, one optimization problem is divided into a plurality of problem expressions. The problem expressions corresponding to the conversion patterns are converted into coefficient matrices by the conversion and coefficient matrix generation unit 13, while the problem expressions not corresponding to the conversion patterns are converted into coefficient matrices by the expression expansion unit 14, the expression organizing unit 15, and the coefficient matrix generation unit 16. These coefficient matrices are then integrated into one coefficient matrix. Then, the integration unit 17 outputs the integrated coefficient matrix as a matrix of the model used to solve the optimization problem, for example, a QUBO matrix. At this time, if there is only one coefficient matrix generated by the conversion and coefficient matrix generation unit 13, the integration unit 17 may output such a coefficient matrix, while if there is only one coefficient matrix generated by the coefficient matrix generation unit 16, the integration unit 17 may output such a coefficient matrix.

The integration unit 17 may integrate the conversion formula derived by converting the problem expression by the conversion and coefficient matrix generation unit 13 and the conversion formula derived by expanding and organizing the problem expression by the expression expansion unit 14 and the expression organizing unit 15. Then, the integration unit 17 may output the integrated conversion formula as a model to be used for solving the optimization problem.

As described above, in the present disclosure, a conversion pattern consisting of corresponding data between a problem expression and a conversion formula is registered in advance, and a problem expression included in an optimization problem is converted into a conversion formula according to the conversion pattern. This allows the time required for converting an optimization problem into a predetermined form such as a QUBO form to be shortened.

Further, in the present disclosure, an optimization problem is divided into problem expressions, and whether or not the divided problem expressions correspond to the conversion patterns is collectively determined. This further shortens the time required for converting an optimization problem into a predetermined form.

Furthermore, in the present disclosure, when a problem expression does not correspond to a conversion pattern, the problem expression is expanded and organized into a conversion formula, and corresponding data between the problem expression before conversion and the conversion formula after conversion is registered as a new conversion pattern. This allows the time required for converting an optimization problem subject to subsequent conversion into a predetermined form.

In the above description, the case of converting a problem expression of an unconstrained problem has been mainly described as an example. However, the present disclosure is also applicable to a constrained problem if registered as a conversion pattern illustrated in FIG. 4. Even in the case of a constrained problem not registered as a conversion pattern illustrated in FIG. 4, by patterning constrained problems that are equivalent to unconstrained problems, the present disclosure is applicable to constrained problems. For example, since the constrained problem shown as Expression 8 is equivalent to the unconstrained problem shown as Expression 9, by patterning “addition of variable without coefficient=constant,” it is possible to handle constrained problems as well.

$$Constrained problem : {\sum }_{i} {x}_{i} = C \qquad [ Expression 8 ]$$

$$Unconstrained problem : {( {\sum }_{i} {x}_{i} - C )}^{2} \qquad [ Expression 9 ]$$

### Second Example Embodiment

Next, a second example embodiment of the present disclosure will be described with reference to the drawings. It should be noted that the drawings may be related to any of the example embodiment.

An information processing apparatus in this example embodiment has the same configuration as that of the first example embodiment described above. The information processing apparatus also includes the configuration described below. Hereinafter, the configuration different from that described above will be mainly explained.

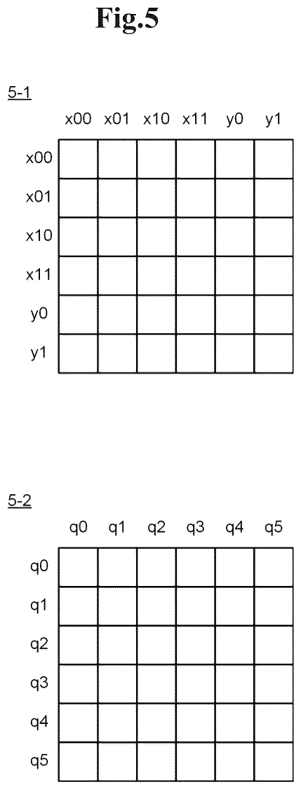

The conversion pattern determination unit 12 (assignment unit) included in the information processing apparatus in this example embodiment has a function of calculating and assigning a serial index (serial number) for the indices (numbers) of variables used in a problem expression of an optimization problem. For example, as illustrated in FIG. 5 (5-1), in the case of a one-dimensional index y[i] or a two-dimensional index x[i][j], serial indices q0 to q5 are calculated and assigned as illustrated in FIG. 5 (5-2). Specifically, the conversion pattern determination unit 12 calculates the serial index in the following manner for example. In the case of one dimension: start+i

$$Example : y [ 1 ] = q 4 + 1 = q 5$$

$$In the case of two dimensions : start + i * stride + j$$

$$Example : x [ 1 ] [ 0 ] = q 0 + 1 * 2 + 0 = q 2$$

Note that the conversion pattern determination unit 12 preferably performs calculation and assignment of serial indices of variables collectively when determining the conversion pattern described above. This can reduce duplicated processing in the calculation of the indices of variables. For example, in the example of FIG. 5, the number of times of calculation can be reduced to the number of variables x and y. As a result, the time required for converting an optimization problem into a predetermined form can be shortened. However, the calculation and assignment of serial indices of variables mentioned above is not necessarily limited to be performed at the time of determining the conversion pattern. They may be performed at any time before conversion of the problem expression.

### Third Example Embodiment

Next, a third example embodiment of the present disclosure will be described. A solving device in this example embodiment includes a solving unit that solves an optimization problem using a coefficient matrix output as described above. That is, the solving device solves an optimization problem by using a QUBO model such as the one shown in Expression 2 using a QUBO matrix that is an output coefficient matrix for example, by the method of simulated annealing. However, the solving device is not limited to solving a QUBO model, and may solve a model using a coefficient matrix of another form output from an information processing apparatus.

The function of solving using the coefficient matrix described above may be provided by the information processing apparatus described in the first and second example embodiments. That is, the information processing apparatus described in the first and second example embodiments may convert an optimization problem into a coefficient matrix and also perform solution computation using the coefficient matrix.

### Fourth Example Embodiment

Next, a fourth example embodiment of the present disclosure will be described with reference to the drawings. In this example embodiment, an outline of the information processing apparatus and the like described in the above example embodiments will be shown. The drawings may be related to any of the example embodiments.

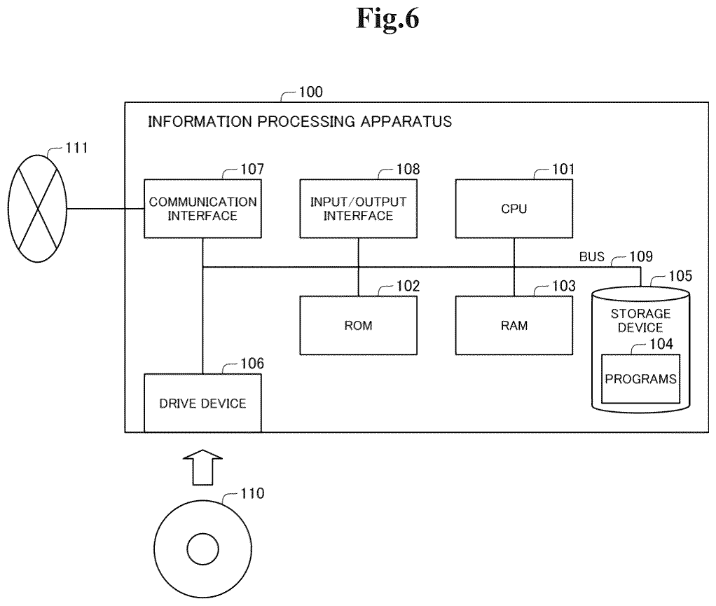

First, the hardware configuration of an information processing apparatus 100 in the present disclosure will be described. The information processing apparatus 100 is configured as a general information processing apparatus and, as an example, includes the following hardware configuration as illustrated in FIG. 6.
a CPU (Central Processing Unit) 101 (arithmetic logic unit);
a ROM (Read Only Memory) 102 (memory unit);
a RAM (Random Access Memory) 103 (memory unit);
programs 104 to be loaded into the RAM 103
a storage device 105 storing the programs 104;
a drive device 106 that performs reading from and writing into a storage medium 110 external to the information processing apparatus;
a communication interface 107 connected to a communication network 111 external to the information processing apparatus;
an input/output interface 108 for performing input/output of data; and
a bus 109 connecting the components.

Note that FIG. 6 illustrates an example of a hardware configuration of an information processing apparatus that is the information processing apparatus 100, and the hardware configuration of the information processing apparatus is not limited to the aforementioned case. For example, the information processing apparatus may include part of the configuration described above, such as not including the drive device 106. Moreover, the information processing apparatus may use a GPU (Graphic Processing Unit), a DSP (Digital Signal Processor), an MPU (Micro Processing Unit), an FPU (Floating point number Processing Unit), a PPU (Physics Processing Unit), a TPU (Tensor Processing Unit), a quantum processor, a microcontroller, or a combination thereof, instead of the aforementioned CPU.

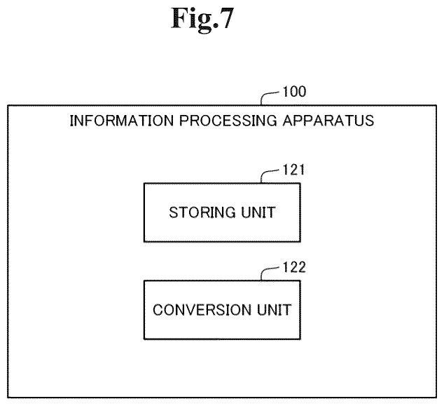

The information processing apparatus 100 can construct and include a storing unit 121 and a conversion unit 122 illustrated in FIG. 7 by the CPU 101 acquiring and executing the programs 104. The programs 104 are, for example, stored in advance in the storage device 105 or the ROM 102, and are loaded into the RAM 103 and executed by the CPU 101 as necessary. In addition, the programs 104 may be provided to the CPU 101 via the communication network 111, or the programs may be stored in advance in the storing unit 110 and read out by the drive device 106 and provided to the CPU 101. However, the storing unit 121 and the conversion unit 122 may be constructed from dedicated electronic circuits for realizing such means.

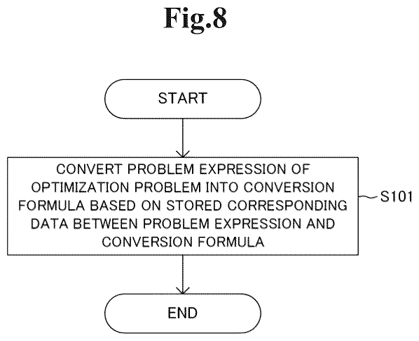

The storing unit 121 stores corresponding data in which a problem expression and a conversion formula derived by expanding and organizing the problem expression are associated with each other. Then, on the basis of the corresponding data, the conversion unit 122 converts an optimization problem including a problem expression into a predetermined form using the conversion formula (step S101 in FIG. 8).

In the above configuration, the information processing apparatus 100 first stores corresponding data in which a pre-set problem expression and a conversion formula derived by previously expanding and organizing the problem expression are associated with each other. Then, the conversion unit 122 checks whether or not a problem expression included in an optimization problem is stored as corresponding data, and when it is stored, converts the problem expression into the conversion formula based on the corresponding data. As a result, it is possible to reduce the processing of expanding and organizing the problem expression included in the optimization problem. As a result, the time required for converting the optimization problem into a predetermined form can be reduced.

Note that at least one or more functions of the storing unit 121 and the conversion unit 122 mentioned above may be executed by an information processing apparatus installed and connected anywhere on the network. That is, it may be executed by so-called cloud computing.

The programs described above can be stored using various types of non-transitory computer-readable media and provided to a computer. Non-transitory computer-readable media include various types of tangible storage media. Examples of non-transitory computer-readable media include magnetic recording media (e.g., flexible disk, magnetic tape, hard disk drive), magneto-optical recording media (e.g., magneto-optical disk), read only memory (CD-ROM), CD-R, CD-R/W, and semiconductor memories (e.g., mask ROM, programmable ROM, Erasable PROM, flash ROM, random access memory (RAM)). In addition, a program may be provided to a computer by various types of transitory computer-readable media. Examples of transitory computer-readable media include electrical signals, optical signals, and electromagnetic waves. The transitory computer-readable medium may provide a program to the computer via a wired communication channel such as an electric wire or an optical fiber, or a wireless communication channel.

While the present disclosure has been described with reference to the example embodiments, the present disclosure is not limited to the above-described example embodiments. The configuration and details of the present disclosure can be changed in a variety of ways that those skilled in the art can understand within the scope of the present disclosure. Furthermore, the above-described example embodiments can be appropriately combined with other example embodiments.

### <Supplementary Note>

The whole or part of the example embodiments disclosed above can be described as the following supplementary notes. Hereinafter, the outlines of the configurations of an information processing apparatus, an information processing method, and a program in the present disclosure will be described. However, the present disclosure is not limited to the configurations described in the following supplementary notes.

Note that the configurations and some or all of the functions based on these configurations described in supplementary notes 2 to 7, which depend on supplementary note 1, may also be dependent on other supplementary notes 8 and 10 with similar dependent relationships as those in supplementary notes 2 to 7. Furthermore, not limited to supplementary notes 1, 8, and 10, within the scope not deviating from the respective example embodiments described above, some or all of the configurations described as supplementary notes and the functions based on those configurations may also be dependent on similar hardware, software, various recording means for recording software, or systems.

### (Supplementary Note 1)

An information processing apparatus comprising:
a storing unit that stores corresponding data in which a problem expression and a conversion formula derived by converting the problem expression by expanding and organizing the problem expression are associated with each other; and
a conversion unit that, on the basis of the corresponding data, convert an optimization problem including the problem expression into a predetermined form using the conversion formula.

### (Supplementary Note 2)

The information processing apparatus according to supplementary note 1, further comprising
a determination unit that determines whether or not the problem expression included in the optimization problem is included in the corresponding data, wherein
when the problem expression is determined to be included in the corresponding data, the conversion unit converts the problem expression of the optimization problem on the basis of the corresponding data, and when the problem expression is determined not to be included in the corresponding data, the conversion unit converts the problem expression of the optimization problem by expanding and organizing the problem expression.

### (Supplementary Note 3)

The information processing apparatus according to supplementary note 2, further comprising
a dividing unit that divides the optimization problem into the problem expressions in predetermined units, wherein
for each of the divided problem expressions, the determination unit determines whether or not the divided problem expression is included in the corresponding data, and
for each of the divided problem expressions, when the divided problem expression is determined to be included in the corresponding data, the conversion unit converts the problem expression on the basis of the corresponding data, while when the divided problem expression is determined not to be included in the corresponding data, the conversion unit converts the problem expression by expanding and organizing the problem expression, and the conversion unit converts the optimization problem by integrating the converted problem expressions.

### (Supplementary Note 4)

The information processing apparatus according to supplementary note 2, wherein
the conversion unit associates a formula derived by converting the problem expression of the optimization problem by expanding and organizing the problem expression with the problem expression as the conversion formula corresponding to the problem expression before the conversion, and stores, in the storing unit, the corresponding data in which the problem expression and the conversion formula are associated with each other.

### (Supplementary Note 5)

The information processing apparatus according to supplementary note 1, further comprising
an assignment unit that, before the conversion, calculates and assigns a serial index of a variable used in the optimization problem on the basis of the problem expression of the optimization problem.

### (Supplementary Note 6)

The information processing apparatus according to supplementary note 1, wherein
the conversion unit converts the optimization problem into a form of a matrix including a coefficient of a variable in a formula derived by converting the optimization problem.

### (Supplementary Note 7)

The information processing apparatus according to supplementary note 6, further comprising
a solving unit that solves the optimization problem using the matrix.

### (Supplementary Note 8)

An information processing method comprising:
on the basis of corresponding data that is stored and in which a problem expression and a conversion formula derived by converting the problem expression by expanding and organizing the problem expression are associated with each other, converting an optimization problem including the problem expression into a predetermined form using the conversion formula.

### (Supplementary Note 9)

The information processing method according to supplementary note 8, further comprising:
determining whether or not the problem expression included in the optimization problem is included in the corresponding data; and
when the problem expression is determined to be included in the corresponding data, converting the problem expression of the optimization problem on the basis of the corresponding data, and when the problem expression is determined not to be included in the corresponding data, converting the problem expression of the optimization problem by expanding and organizing the problem expression.

### (Supplementary Note 9.1)

The information processing method according to supplementary note 9, further comprising:
dividing the optimization problem into the problem expressions in predetermined units;
for each of the divided problem expressions, determining whether or not the divided problem expression is included in the corresponding data; and
for each of the divided problem expressions, when the divided problem expression is determined to be included in the corresponding data, converting the problem expression on the basis of the corresponding data, while when the divided problem expression is determined not to be included in the corresponding data, converting the problem expression by expanding and organizing the problem expression, and converting the optimization problem by integrating the converted problem expressions.

### (Supplementary Note 9.2)

The information processing method according to supplementary note 9, further comprising
associating a formula derived by converting the problem expression of the optimization problem by expanding and organizing the problem expression with the problem expression as the conversion formula corresponding to the problem expression before the conversion, and storing the corresponding data in which the problem expression and the conversion formula are associated with each other.

### (Supplementary Note 9.3)

The information processing method according to supplementary note 8, further comprising,
before the converting, calculating and assigning a serial index of a variable used in the optimization problem on the basis of the problem expression of the optimization problem.

### (Supplementary Note 9.4)

The information processing method according to supplementary note 8, further comprising
converting the optimization problem into a form of a matrix including a coefficient of a variable in a formula derived by converting the optimization problem.

### (Supplementary Note 9.5)

The information processing method according to supplementary note 9.4, further comprising
solving the optimization problem using the matrix.

### (Supplementary Note 10)

A program for causing an information processing apparatus to execute processing to,
on the basis of corresponding data that is stored and in which a problem expression and a conversion formula derived by converting the problem expression by expanding and organizing the problem expression are associated with each other, convert an optimization problem including the problem expression into a predetermined form using the conversion formula.

REFERENCE SIGNS LIST

| | |
|---|---|
| 10 | information processing apparatus |
| 11 | dividing unit |
| 12 | conversion pattern determination unit |
| 13 | conversion and coefficient matrix generation unit |
| 14 | expression expansion unit |
| 15 | expression organizing unit |
| 16 | coefficient matrix generation unit |
| 17 | integration unit |
| 18 | conversion pattern storing unit |
| 100 | information processing apparatus |
| 101 | CPU |
| 102 | ROM |
| 103 | RAM |
| 104 | programs |
| 105 | storing device |
| 106 | drive device |
| 107 | communication interface |
| 108 | input/output interface |
| 109 | bus |
| 110 | storage medium |
| 111 | communication network |
| 121 | storing unit |
| 122 | conversion unit |

1. An information processing apparatus comprising:
at least one memory configured to store instructions; and
at least one processor configured to execute instructions to:
store corresponding data in which a problem expression and a conversion formula derived by converting the problem expression by expanding and organizing the problem expression are associated with each other; and
on a basis of the corresponding data, convert an optimization problem including the problem expression into a predetermined form using the conversion formula.

2. The information processing apparatus according to claim 1, wherein the at least one processor is configured to execute the instructions to:
determine whether or not the problem expression included in the optimization problem is included in the corresponding data; and
when the problem expression is determined to be included in the corresponding data, convert the problem expression of the optimization problem on the basis of the corresponding data, and when the problem expression is determined not to be included in the corresponding data, convert the problem expression of the optimization problem by expanding and organizing the problem expression.

3. The information processing apparatus according to claim 2, wherein the at least one processor is configured to execute the instructions to:
divide the optimization problem into the problem expressions in predetermined units;
for each of the divided problem expressions, determine whether or not the divided problem expression is included in the corresponding data; and
for each of the divided problem expressions, when the divided problem expression is determined to be included in the corresponding data, convert the problem expression on the basis of the corresponding data, while when the divided problem expression is determined not to be included in the corresponding data, convert the problem expression by expanding and organizing the problem expression, and convert the optimization problem by integrating the converted problem expressions.

4. The information processing apparatus according to claim 2, wherein the at least one processor is configured to execute the instructions to
associate a formula derived by converting the problem expression of the optimization problem by expanding and organizing the problem expression with the problem expression as the conversion formula corresponding to the problem expression before the conversion, and store the corresponding data in which the problem expression and the conversion formula are associated with each other.

5. The information processing apparatus according to claim 1, wherein the at least one processor is configured to execute the instructions to,
before the conversion, calculate and assign a serial index of a variable used in the optimization problem on a basis of the problem expression of the optimization problem.

6. The information processing apparatus according to claim 1, wherein the at least one processor is configured to execute the instructions to
convert the optimization problem into a form of a matrix including a coefficient of a variable in a formula derived by converting the optimization problem.

7. The information processing apparatus according to claim 6, wherein the at least one processor is configured to execute the instructions to
solve the optimization problem using the matrix.

8. An information processing method comprising:
on a basis of corresponding data that is stored and in which a problem expression and a conversion formula derived by converting the problem expression by expanding and organizing the problem expression are associated with each other, converting an optimization problem including the problem expression into a predetermined form using the conversion formula.

9. The information processing method according to claim 8, further comprising:
determining whether or not the problem expression included in the optimization problem is included in the corresponding data; and
when the problem expression is determined to be included in the corresponding data, converting the problem expression of the optimization problem on the basis of the corresponding data, and when the problem expression is determined not to be included in the corresponding data, converting the problem expression of the optimization problem by expanding and organizing the problem expression.

10. The information processing method according to claim 9, further comprising
dividing the optimization problem into the problem expressions in predetermined units;
for each of the divided problem expressions, determining whether or not the divided problem expression is included in the corresponding data; and
for each of the divided problem expressions, when the divided problem expression is determined to be included in the corresponding data, converting the problem expression on the basis of the corresponding data, while when the divided problem expression is determined not to be included in the corresponding data, converting the problem expression by expanding and organizing the problem expression, and converting the optimization problem by integrating the converted problem expressions.

11. The information processing method according to claim 9, further comprising
associating a formula derived by converting the problem expression of the optimization problem by expanding and organizing the problem expression with the problem expression as the conversion formula corresponding to the problem expression before the conversion, and storing the corresponding data in which the problem expression and the conversion formula are associated with each other.

12. The information processing method according to claim 8, further comprising,
before the converting, calculating and assigning a serial index of a variable used in the optimization problem on a basis of the problem expression of the optimization problem.

13. The information processing method according to claim 8, further comprising
converting the optimization problem into a form of a matrix including a coefficient of a variable in a formula derived by converting the optimization problem.

14. The information processing method according to claim 13, further comprising
solving the optimization problem using the matrix.

15. A non-transitory computer-readable medium storing thereon a program comprising instructions for causing a computer to execute processing to,
on a basis of corresponding data that is stored and in which a problem expression and a conversion formula derived by converting the problem expression by expanding and organizing the problem expression are associated with each other, convert an optimization problem including the problem expression into a predetermined form using the conversion formula.
